(19) United States
(12) Patent Application Publication
(10) Pub. No.: US 2009/0277231 A1
(43) Pub. Date: Nov. 12, 2009

(54) Apparatus For Door Lock

(76) Inventor: Gab Sik Kim, Seoul (KR)

Correspondence Address: IPHORGAN, LTD., 1130 LAKE COOK ROAD, SUITE 240, BUFFALO GROVE, IL, 60089, US

(21) Appl. No.: 11/887,327

(22) PCT Filed: Apr. 4, 2006
(86) PCT No.: PCT/KR2006/001234

§ 371 Date: Jan. 15, 2008

(30) Foreign Application Priority Data
Apr. 4, 2005 (KR) 10-2005-0028260

(51) Int. Cl. E05B 51/00; E05B 35/00

(52) U.S. Cl. 70/275; 70/336

(57) ABSTRACT

A door lock system for locking and unlocking a door, which ensures a normal operation of a driving motor even if interference occurs in a locker while locking and unlocking operations are performed, by delivering a rotation force of the driving motor to the locker through a torsion spring. The door lock system includes: a driving motor which rotates clockwise and counter-clockwise with a predetermined quantity of rotation in response to a door locking signal and a door unlocking signal, respectively; a locker which locks and unlocks a door while rotating by receiving a driving force of the driving motor; and a rotating gear group which has an upper rotating gear that is disposed between the driving motor and the locker and delivers a rotation force, a lower rotating gear, and a torsion spring.

### TECHNICAL FIELD

The present invention relates to a door lock system for locking or unlocking a door, and more particularly, to a door lock system which has an improved durability and reliability by delivering a rotation force of a driving motor disposed inside the door lock system to a locker through a torsion spring, thereby preventing malfunctioning due to interference occurring in use and preventing quick battery exhausting.

### BACKGROUND ART

A door lock system is widely used in a house's front door, a gate of an apartment, business, or office, a bank safe, a wardrobe, and a storage compartment. Recently, with the development of a new door lock system in which a door can be open and closed using an electronic key, a user can use the door lock system in a more convenient and reliable manner.

In general, an authentication key including an electronic chip is used in a door lock system using an electronic key. When the authentication key comes in contact with a sensor, a motor included in the door lock system operates to deliver a driving force to a locker that is inserted into a locking notch of a door frame through a gear disposed therein. Thereafter, when the locker is separated from the locking notch, the door becomes unlocked.

However, in the conventional door lock system, the door lock system has easily been damaged due to interference, for example, the locker is stuck when the door is open and closed. That is, although the motor tries to move the locker to an unlocking position under the control of a controller, the locker cannot move due to the interference above. As a result, the motor continues to be under a load, causing overheating and damaging.

In order to solve the problem described above, a method may be taken into consideration in which the motor is replaced by a servo motor that rotates clockwise and counter-clockwise according to a load applied to the locker, so that the door can be avoided from being stuck or malfunctioning caused by the interference. However, continuous operations of the servo motor may cause excessive battery exhaustion. Furthermore, the user may have to repeatedly check whether the door is locked, or may have to operate the door lock system by contacting the authentication key again, causing inconvenience in use.

In addition, the conventional door lock system has a drawback in that a third party can easily unlock the door by inserting a tool (e.g. card, driver, etc) between the door and door frame.

### SUMMARY OF THE INVENTION

In order to solve the aforementioned problems, an object of the present invention is to provide a door lock system which ensures a normal operation of a driving motor that provides a driving force for locking and unlocking operations of a locker even if interference occurs in the locker while locking and unlocking operations are performed by receiving a rotation force of the driving motor to the locker through a torsion spring, and when the interference is removed, the locking and unlocking operations of the locker are performed by receiving a rotation force due to an elastic force of the torsion spring.

Another object of the present invention is to provide a door lock system capable of reducing battery exhaustion.

Another object of the present invention is to provide a door lock system having a safety lock function for preventing a door from unlocking in an in appropriate manner by arbitrarily operating a locker inserted into a locking notch of a door frame from outside.

Another object of the present invention is to provide a door lock system capable of preventing a locker from damaging when a locker is lowered in a state that a door is open.

Another object of the present invention is to provide a door lock system that can be open with a minimum damage in a compulsive manner when a compulsive opening is necessary due to a key loss, a password loss, or malfunctioning.

According to an aspect of the present invention, there is provided a door lock system comprising: a driving motor which is disposed inside a lock case, has a gear at an end of a motor-axis, and rotates clockwise and counter-clockwise with a predetermined quantity of rotation in response to a door locking signal and a door unlocking signal, respectively; a locker which has a gear engaged at one side, and moves between the door locking position and the door unlocking position through an aperture formed at one side of the lock case by receiving a driving force of the driving motor; and a rotating gear group comprising: an upper rotating gear which is disposed between the driving motor and the locker, and rotates along with a motor-axis gear by receiving a rotation force of the motor-axis gear; a lower rotating gear which is disposed at the lower portion of the upper rotating gear, and rotates the gear of the locker while rotating; and a torsion spring which is disposed between the upper rotating gear and the lower rotating gear and converts the rotation force of the upper rotating gear into an elastic force of a spring to be delivered to the lower rotating gear as a rotation force of the lower rotating gear, and thus allows the driving motor to be able to rotate in a predetermined quantity of rotation even when interruption occurs in the locker.

In the aforementioned aspect of the present invention, the locker may be fastened about a rotation axis formed in the lock case in a rotatable manner, and the gear may have a circular arc shaped engaging surface so that the rotation of the lower rotating gear can be delivered.

In addition, a first hook piece and a second hook piece may be respectively protruded from the lower surface of the upper rotating gear and the upper surface of the lower rotating gear, the first hook piece and the second hook piece may be disposed between both ends of the torsion spring, and the lower rotating gear may rotate if one end of the torsion spring presses the second hook piece due to an elastic force produced when a second end of the torsion spring is pressed by the first hook piece while the upper rotating gear rotates.

In addition, the both ends of the torsion spring may extend in a cross manner with each other, and the driving motor may have quantity of rotation in excess of a suitable rotation range of the lower rotating gear.

In addition, a stage hook may be formed with one stage in the rear side of the locker, and the door lock system may further comprise: a lever driving cam which is formed in the upper side of the upper rotating gear in an integrated manner, and includes a first portion having a short rotation diameter and a second portion having a long rotation diameter; and a safety lever comprising: a first lever which is fastened about a rotation axis formed inside the lock case in a rotatable manner, and of which an end can be located on a rotation path of the stage hook; and a second lever which is integrated with the first lever and which extends in contact with the outer circumferential surface of the lever driving cam, so that the first lever does not interfere the rotation of the locker that moves from the door locking position to the door unlocking position when a contact position changes from the first portion to the second portion while the lever driving cam rotates, and thus the first lever moves from the rotation path of the stage hook; and

In addition, a locker hole may be formed in a rotation center where the rotation axis is joined, a through-hole may be formed in the lateral side of the locker hole and allows the outer circumferential surface at the lower portion of the stage hook, in which the first lever of the safety lever is adjacent when the locker is in the locking position, to be connected with the inside of the locker hole, and the through-hole may have a compulsive opening pin of which a first end is protruded inwards of the locker hole and which has a suitable length for the second end to push the first lever of the safety lever when the first end is pushed in the direction of the outer circumferential surface so as to move out of a rotation path of the stage hook.

### BRIEF DESCRIPTION OF THE DRAWING FIGURES

FIG. 1 is an exploded perspective view of a door lock system according to an embodiment of the present invention;

FIG. 2 is a plan view of a door lock system in a locking position according to an embodiment of the present invention;

FIGS. 3 to 6 show the operations of a door lock system in a sequential manner according to an embodiment of the present invention;

FIGS. 7(a)-(c′) illustrate in schematic views the operation of a torsion spring when a locker of a door lock system moves from a locking position to an unlocking position;

FIG. 8 shows a door lock system when a locker is interfered in a locking position;

FIGS. 9 (a)-(d) are schematic views showing the operation of a torsion spring when a door lock system is in the state of FIG. 8;

FIG. 10 is a plan view showing the operation of a safety lever according to an embodiment of the present invention;

FIGS. 11 and 12 are partial detail views showing the operation of a supporting portion according to an embodiment of the present invention;

FIG. 13 shows a door lock system prior to being open in a compulsive manner, according to an embodiment of the present invention; and

FIGS. 14 to 15 show compulsive opening structures of a door lock system according to an embodiment of the present invention.

### DETAILED DESCRIPTION OF THE PREFERRED EMBODIMENTS

Hereinafter, the present will be described in detail with reference to accompanying drawings.

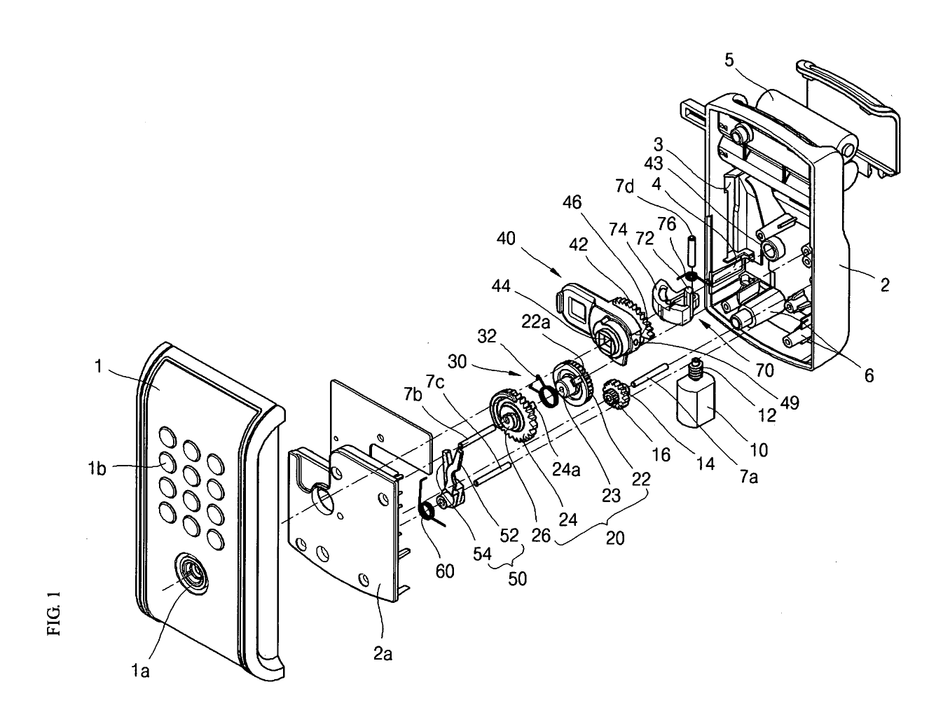

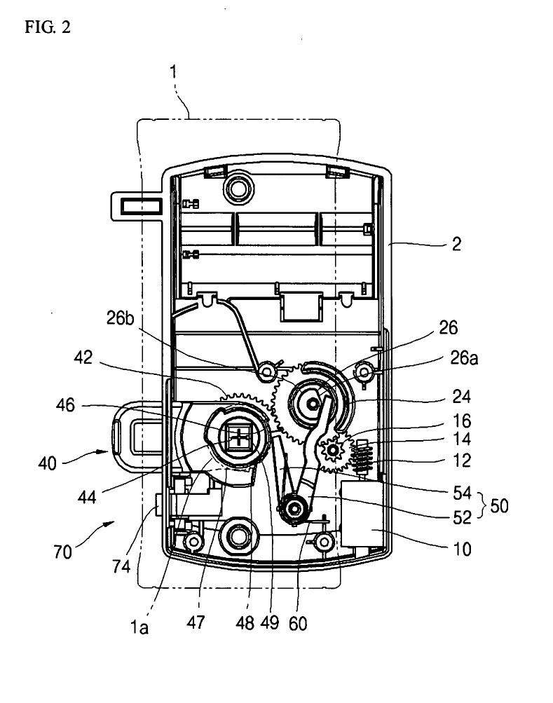

FIG. 1 is an exploded perspective view of a door lock system according to an embodiment of the present invention. FIG. 2 is a plan view of a door lock system in a locking position according to an embodiment of the present invention.

Referring to the drawings, the door lock system includes a front cover 1 having a button portion 1b and/or a key contact portion 1a. In the door lock system, locking and unlocking operations are performed by inputting a password through the button portion 1b or the key contact portion 1a.

A fastening cover 2a is connected inside a lock case 2 from a front side thereof for fastening internal elements. A battery 5 is built in at an upper rear side of the lock case 2 so as to supply power to the door lock system. A controller (not shown) controls overall operations of the door lock system, and is generally provided in the form of a printed circuit board (PCB). A plurality of supporting ribs 6 is disposed inside the lock case 2. Rotation pins 7a, 7b, 7c, and 7d are connected to each of the supporting ribs 6 so as to support members to be described below.

A driving motor 10 is disposed at the lower inner side of the lock case 2. The driving motor 10 receives power from the battery 5 and rotates clockwise and counter-clockwise in accordance with a predetermined quantity of rotation in response to a locking or unlocking signal of the controller. A warm gear 12 is disposed at an end of a motor-axis of the driving motor 10 as a motor-axis gear. In this description, the motor-axis gear is defined as a gear installed at the motor-axis.

A driving gear 14 which is engaged with the warm gear 12 and an operation gear 16 which is coaxially connected to the driving gear 14 in an integrated manner are supported by the rotation pin 7a at one side of the warm gear 12. The rotation of the warm gear 12 is slowed down by the driving gear 14 and the operation gear 16 and is delivered to a rotating gear group 20.

The rotating gear group 20 includes an upper rotating gear 24 and a lower rotating gear 22 which are supported about the rotation pin 7b in a rotatable manner and a torsion spring 30 which is disposed between the upper rotating gear 24 and the lower rotating gear 22 and converts a rotation force into an elastic force to be transferred.

Since the upper rotating gear 24 and the lower rotating gear 22 are supported by the rotation pin 7b in a rotatable manner, when the torsion spring 30 is not present, the rotation of the upper rotating gear 24 does not affect the lower rotating gear 22, and the rotation of the lower rotating gear 22 does not affect the upper rotating gear 24.

The upper rotating gear 24 is engaged with the operation gear 16, and thus rotates along with the warm gear 12. A first hook piece 24a contactable to an end 32 of the torsion spring 30 is protruded downwards from the lower surface of the upper rotating gear 24.

The lower rotating gear 22 is engaged with a gear 42 of a locker 42. The lower rotating gear can operate the locker 40 along with the lower rotating gear 22. A second hook piece 22a is protruded upwards from the upper surface of the lower rotating gear 22, and is disposed at the end 32 of the torsion spring 30 in a contactable manner.

The torsion spring 30 is disposed between the upper rotating gear 24 and the lower rotating gear 22, and is inserted into and supported by a center axis 23 of the lower rotating gear 22. The first hook piece 24a of the upper rotating gear 24 and the second hook piece 22a of the lower rotating gear 22 are disposed between both ends 32 of the torsion spring 30 in a contactable manner.

Preferably, the both ends 32 of the torsion spring 30 are crossed each other, and the first hook piece 24a and the second hook piece 22a are disposed between the crossed both ends 32.

Accordingly, the upper rotating gear 24 rotates along with the warm gear 12, and then the first hook piece 24a presses a first side of the end 32 of the torsion spring 30. As a result, the diameter of the torsion spring 30 decreases, and thus the rotation force of the upper rotating gear 24 is converted into an elastic force. In this case, if the second hook piece 22a is not restricted, that is, the lower rotating gear 22 can rotate, then a second side of the end 32 presses the second hook piece 22a using the elastic force of the torsion spring 30, thereby rotating the lower rotating gear 22. However, if the second hook piece 22a is restricted, that is, interference occurs in the locker 40 engaged with the lower rotating gear 22 and thus the lower rotating gear 22 cannot rotate, then the diameter of the torsion spring 30 decreases due to the rotation force of the upper rotating gear 24, and thus the rotation force is converted into an elastic energy to be stored. Thereafter, if the second hook piece 22a becomes not restricted, that is, the interference occurred in the locker 40 is removed, and thus the lower rotating gear 22 can rotate, then the torsion spring 30 is restored. As a result, the second side of the end 32 presses the second hook piece 22a using the elastic force, thereby rotating the lower rotating gear 22.

Preferably, in locking and unlocking positions of the locker 40, the first hook piece 24a and the second hook piece 22a maintain a separation distance determined in a circumferential direction of the torsion spring 30, thereby preventing the locker 40 from moving.

While moving to/from the locking and unlocking positions through an aperture 3 disposed on the left side of the lock case 2, the locker 40 is inserted or separated to/from a locking notch formed in a door frame to lock or unlock the door. The gear 42 is disposed at one rear side of the locker 40, and is engaged with the lower rotating gear 22.

As shown in the drawing, the locker 40 may perform a locking operation in a rotatable manner, or may perform the locking operation while moving in a horizontal direction. If the locker 40 is included in a door lock system which performs locking or unlocking operations by moving the aperture 3 in a horizontal direction, the gear 42 is a rack gear type. On the other hand, if the locker 40 is included in a door lock system which is supported by and rotates about a rotation axis 43 formed in the lock case 2, and thus is inserted into or discharged out of the locking notch so as to lock or unlock the door, then the gear 42 has a circular arc shaped engaging surface and receives a rotation force of the lower rotating gear 22. This will be included in the scope of claims of the present invention.

Preferably, the present invention further includes an antitheft safety lever 50, so that the locker 40 cannot be unlocked at a locking position, in which the locker 40 is inserted into the locking notch of the door frame, by an abnormal unlocking operation, for example, by an electronic key touch operation and/or a password input operation.

The antitheft safety lever 50 includes a first lever 54 of which a rotation axis is inserted into the rotation pin 7c so as to be fastened in a rotatable manner and which extends towards the rear side of the locker 40, and a second lever 52 which is integrated with the first lever 54 in a specific angle and extends towards the front side of the upper rotating gear 24.

A stage hook 46 is formed with one stage in the rear side of the locker 40. The end of the first lever 54 can be located on a rotation path of the stage hook 46, and supports the stage hook 46 in a contactable manner when the locker 40 moves from the unlocking position to the locking position at this location so as to prevent the locker 40 from moving.

The second lever 52 extends towards the front side of the rotating gear 24 and comes in contact with the outer circumferential surface of a lever driving cam 26. In the second lever 52, the outer and inner circumferential surfaces of the lever driving cam 26 come in contact with each other, so that the second lever 52 can operate along the outer circumferential surface, thereby moving the first lever 54.

A spring 60 is disposed at a rotation axis of the antitheft safety lever 50 and provides an elastic force to the left (with respect to FIG. 2) so that the second lever 52 of the antitheft safety lever 50 comes in contact with the outer circumferential surface of the lever driving cam 26. Thus, the antitheft safety lever 50 can rotate along with the lever driving cam 26.

The lever driving cam 26 is integrated and co-rotates with the upper rotating gear 24 disposed in the front side of the upper rotating gear 24. The outer circumferential surface of the lever driving cam 26 includes a first portion 26a having a short rotation diameter and a second portion 26b having a long rotation diameter. That is, with respect to the rotation axis of the upper rotating gear 24, the first portion 26a has a short diameter, and the second portion 26b has a long diameter. Preferably, the first portion 26a has two tilted surfaces in the form of a triangle, and the second portion 26b has a circular arc shaped surface.

In the state that the locker 40 is in the locking position, the first lever 54 comes in contact with the stage hook 46 when the locker 40 rotates towards the unlocking position, so as to prevent the locker 40 from rotating. Here, the second lever 52 stays in contact with the first portion 26a around the outer circumferential surface of the lever driving cam 26. Accordingly, when a malicious user tries to separate the locker 40 from the locking notch so that the locker 40 moves to the unlocking position by inserting a tool (e.g. card or driver) between the door frame and the door, the stage hook 46 of the locker 40 and the first lever 54 come in contact with each other, thereby preventing the locker 40 from moving in an inappropriate manner.

However, if the driving motor 10 rotates in response to a normal signal, and thus its driving force is delivered to the upper rotating gear 24, then the lever driving cam 26 rotates along with the rotating gear 24. As a result, the second lever 52 comes in contact with the second portion 26b of the lever driving cam 26. The second portion 26b having a large rotation diameter allows the second lever 52 to rotate to the right along with the lever driving cam 26. As a result, the first lever 54 also moves to the right, thereby moving to a position where the first lever 54 does not come in contact with the stage hook 46.

Accordingly, the antitheft safety lever 50 can prevent the locker 40 from moving if the driving motor 10 rotates under the control of the controller so as to rotate the upper rotating gear 24.

Preferably, the door lock system according to an embodiment of the present invention further includes a supporting portion 70 for preventing the locker 40 from protruding outwards when the door is open.

The supporting portion 70 includes a body 74, a supporting lever 72, and an operating spring 76. A tilt portion 47 is formed in the rear side of the locker 40 for operating the supporting portion 70.

The body 74 is rotatably supported by the rotation pin 7d at the lower side of the locker 40 in a direction perpendicular to the rotation direction of the locker 40, and rotates by being protruded outwards or being inserted inwards of a through-hole 4 formed at the lower side of the aperture 3. A support lever 72 extends towards the upper side of the body 74. When the body 74 is protruded, the support lever 72 comes in contact with the tilt portion 47 of the locker 40 located at the unlocking position so as to prevent the locker 40 from rotating. However, when the body 74 rotates, the support 72 does no longer come in contact with the tilt portion 47, and thus the locker 40 can rotate towards the locking position.

When the locker 40 is in the unlocking position due to the operating spring 76 inserted into the rotation pin 7d, the body 74 receives an elastic force so that the body 74 is protruded through the through-hole 4.

Hereinafter, the operation of the door lock system of the present invention will be described in detail.

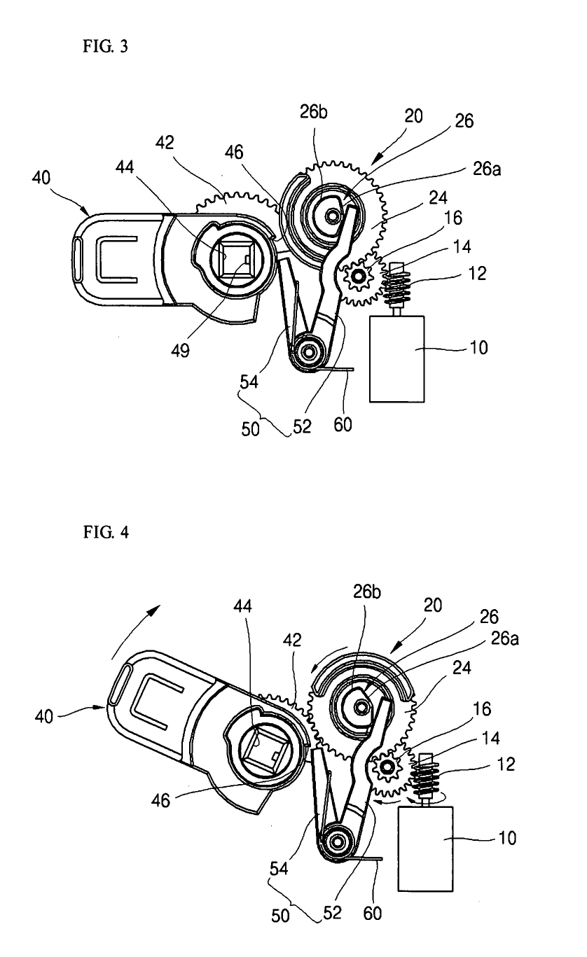

FIGS. 3 to 6 illustrate a door lock system according to an embodiment of the present invention, and sequentially show a process in which an unlocking operation is performed due to rotation of a locker in a locking position when a driving motor rotates.

FIG. 3 illustrates the door lock system in a locking position. When the door lock system is in the locking position, the locker 40 rotates to be protruded outside the aperture 3 of the lock case 2 (see FIG. 2). In addition, the second lever 52 of the antitheft safety lever 50 comes in contact with the first portion 26a of the lever driving cam 26, and the first lever 54 is located at a position where the first lever 54 can come in contact with the stage hook 46 when the locker 40 rotates.

In this state, the unlocking operation is performed by a password input operation and/or an electronic key touch operation. In addition, the controller provides power so that the driving motor 10 can rotate in a predetermined quantity of rotation.

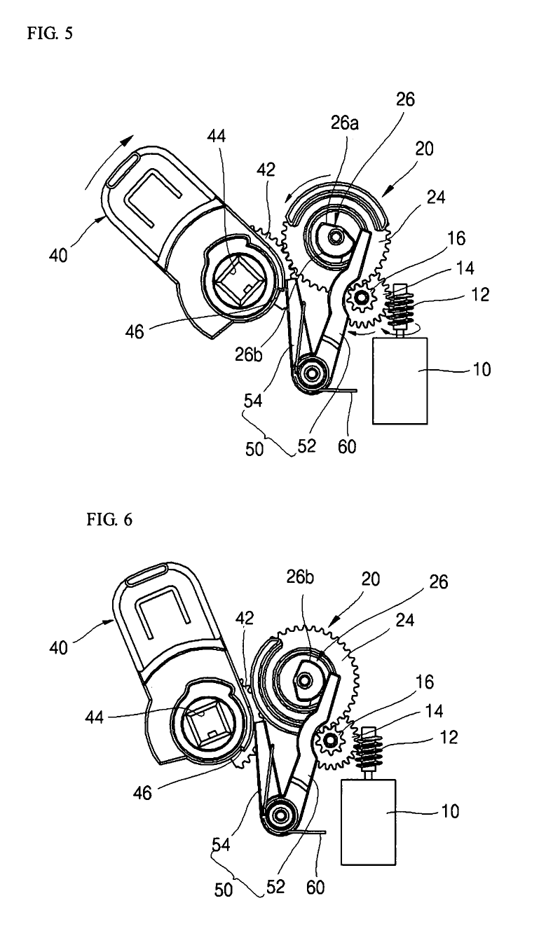

FIG. 4 illustrates the door locking system when the unlocking operation is performed while the driving motor rotates. Referring to FIG. 4, while a motor-axis of the driving motor 10 rotates, the warm gear 12 rotates, and thus the driving gear 14 engaged therewith rotates. The rotation force is delivered to the operation gear 16 coaxially connected to the driving gear 14, and thus the operation gear 16 allows the engaged upper rotating gear 24 to rotate. When the upper rotating gear 24 rotates, the lower rotating gear 22 is rotated by the torsion spring 30. Thus, the rotation force of the lower rotating gear 22 is delivered through the engaged gear 42, thereby rotating the locker 40 clockwise.

Here, the lever driving cam 26 rotates along with the upper rotating gear 24 of the antitheft safety lever 50. When a contact point with respect to the second lever 52 moves from the first portion 26a to the second portion 26b, the second lever 52 moves to the right. When the second lever 52 moves to the right, the first lever 52 engaged therewith also moves to the right, so that the first lever 52 moves to a position where the first lever 52 does not come in contact with the stage hook 46 even if the locker 40 rotates. According to such operation, the first lever 53 moves to the right before the stage hook 46 of the locker 40 reaches a position where the stage hook 46 can come in contact with the first lever 54, and thus the locker 40 can move without being interfered by the antitheft safety lever 50 when the unlocking operation is performed in a normal manner using the rotation of the driving motor 10.

FIG. 5 illustrates the door locking system when the driving motor 10 rotates further in the state of FIG. 4. Here, the locker 40 rotates without being interfered by the first lever 54 of the antitheft safety lever 50.

FIG. 6 illustrates the door lock system when the unlocking operation is completed. The locker 40 of which one end is protruded outside the aperture 3 rotates inwards of the aperture 3 of the lock case 2 due to the rotation of the lower rotating gear 22 and is located inside the lock case 2. As a result, the unlocking operation is completed, and thus the door can be open.

When closing the door, the driving motor 10 rotates in an opposite direction in which the door is open, and thus the locker 40 rotates outwards of the aperture 3 of the lock case 2, and is then inserted into the locking notch.

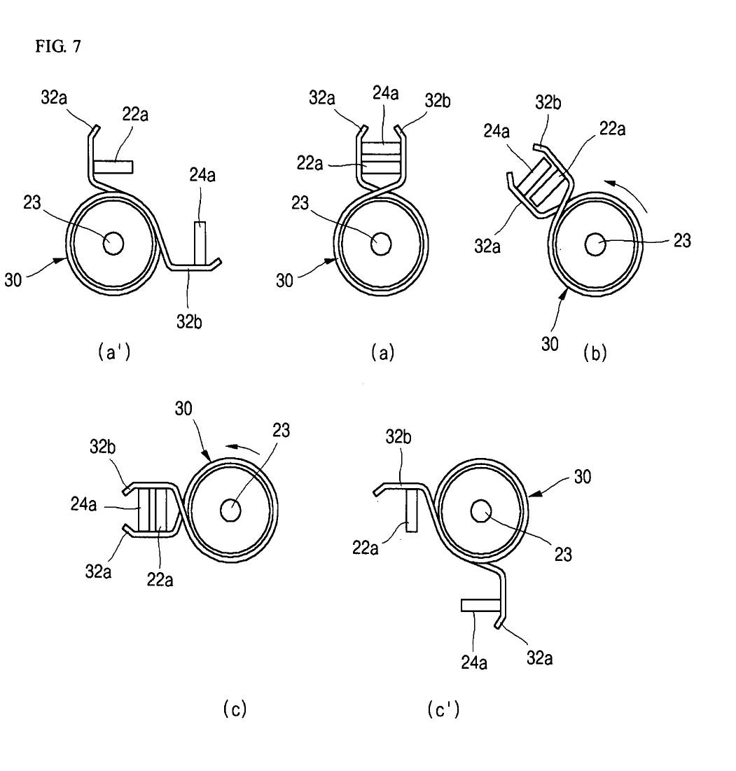

FIG. 7 is a schematic view showing the operation of the torsion spring when the unlocking operation of the door lock system is performed as shown in FIG. 6. For convenience, in FIG. 7, the upper and lower rotating gears are omitted, and only the first hook piece and the second hook piece are shown. Although the first hook piece and the second hook piece have different cross-sections in the drawing, the present invention is not limited thereto.

First, referring to (a) of FIG. 7, the torsion spring is shown when the locker of the door lock system is in the locking position. When the driving motor 10 rotates in response to a signal such as a key touch in the states of (a), the rotation force is delivered so that the upper rotating gear 24 rotates.

Accordingly, the first hook piece 24a presses a first end 32a of the torsion spring 30, and converts the rotation force into an elastic force of the torsion spring 30. Here, since there is no force to restrict the torsion spring 30, the torsion spring 30 is rotated by the elastic force while a second end 32b of the torsion spring 30 presses the second hook piece 22a. As a result, as shown in (b), the first hook piece 24a and the second hook piece 22a rotate in the same direction, and the lower rotating gear 22 and the upper rotating gear 24 rotate in the same direction.

As shown in (c), when the upper rotating gear 24 rotates enough to unlock the locker 40 due to the rotation of the driving motor 10, the lower rotating gear 22 also rotates to cope therewith.

In, FIGS. 7, (a)′ and (c)′ show torsion springs when the locker is in the locking position and the unlocking position according to an embodiment of the present invention.

Referring first to (a)′ in FIG. 7, the end of the locker 40 can be inserted into the locking notch in the state of (a)′, thereby locking the door. However, since shape of the torsion spring 30 does not change in the state of (a), there is no elastic force to prevent the first hook piece 24a and the second hook piece 22a from slightly moving between both ends of the torsion spring 30. As a result, the locker 40 may move slightly. On the other hand, if the first hook piece 24a rotates clockwise in an excess manner, and precess the second end 32b of the torsion spring 30, then the torsion spring 30 is protruded by an elastic force to allow the second hook piece 22a to rotate. However, since the locker 40 is supported in contact with the lower end of the aperture 3 and thus cannot rotate, the locker 40 is firmly fastened to the lower end of the aperture 2. That is, due to an excessive rotation of the driving motor 10 in a locking direction, the locker 40 is firmly fastened in the locking position.

In, FIG. 7, (c)′ shows a torsion spring when the locker is firmly fastened in the unlocking position with the same principle of (a)′. That is, if the driving motor 10 continues to rotate in an excess manner in the unlocking direction after the locker 40 reaches the unlocking position, the first hook piece 24a rotates counter-clockwise in an excess manner, and thus presses and moves the first end 32a of the torsion spring 30. In this state, although the second hook piece 22a tries to rotate counter-clockwise due to the elastic force of the torsion spring 30, the locker 40 does not rotate by being supported inside the lock case 2, and thus is firmly fastened in the unlocking position by the elastic force.

Accordingly, by allowing the driving motor 10 to rotate further than a required quantity of rotation suitable for rotating the locker 40 between the locking position and the unlocking position, the locker 40 can be firmly fastened without moving between the locking position and the unlocking position by the elastic force produced in the torsion spring 30 when the first hook piece 24a and the second hook piece 22a are separated between the locking position and the unlocking position.

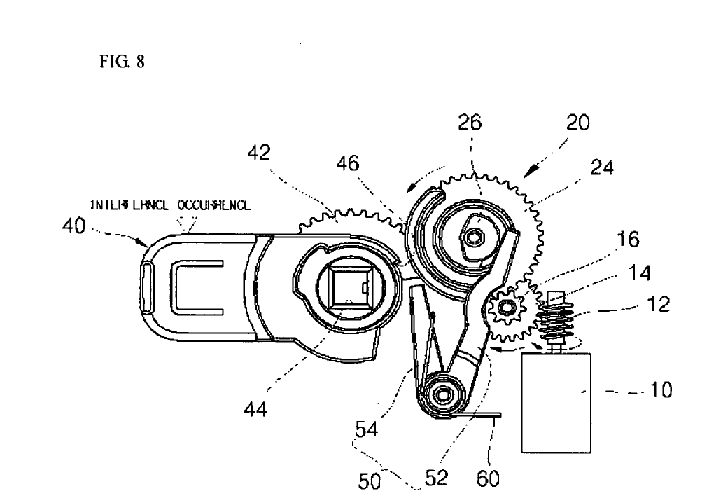

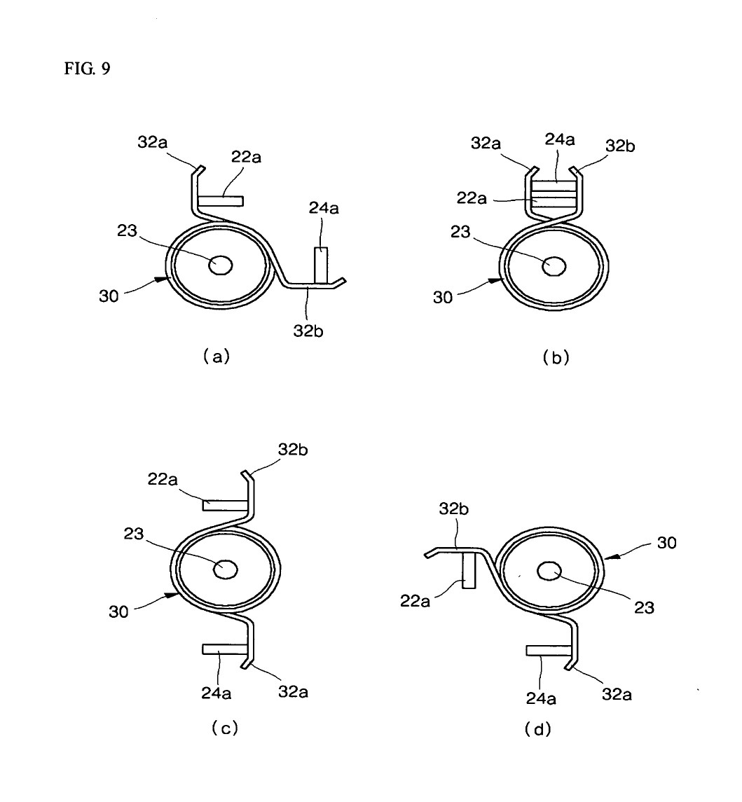

FIG. 8 shows the door lock system when the locker is interfered in the locking position according to an embodiment of the present invention. FIG. 9 shows the operation of the torsion spring of FIG. 8.

Referring to FIG. 8, the driving motor 10 rotates in a predetermined quantity of rotation in response to an unlocking signal. As a result, the upper rotating gear 24, which rotates along with the warm gear 12 due to the driving gear 14 and the operation gear 16, rotates in a corresponding quantity of rotation of the driving motor 10 of the warm gear 12. The lever driving cam 26 rotates along with the upper rotating gear 24, and thus the first lever 54 of the antitheft safety lever 50 moves to the right where the first lever 54 does not come in contact with the locker 40. Since the lower rotating gear 22 is engaged with the gear 42 of the locker 40, the lower rotating gear 22 is restricted by the locker 40, thereby not rotating.

The operation of the torsion spring 30 in this state is shown in FIG. 9. When the driving motor 10 rotates in the state of (a), the upper rotating gear 24 begins to rotate counter-clockwise, and then the first hook piece 24a presses the first end 32a of the torsion spring 30 and rotates counter-clockwise via the state of (b). As a result, the first hook piece 24a and the first end 32a of the torsion spring 30 move to a position of (c).

However, since the second hook piece 22a of the lower rotating gear 22 cannot move due to restriction of the lower rotating gear 22, the second hook piece 22a stays in the state of (a) regardless of pressure inflicted by the second end 32b of the torsion spring 30. Accordingly, the torsion spring 30 changes its shape as shown in (c), and the rotation force applied by the first hook piece 24a is stored as the elastic energy of the torsion spring 30.

In this state, if the interference of the locker 40 is removed, the torsion spring 30 is restored, and thus the second end 32b of the torsion spring 30 presses the second hook piece 22a so as to allow the lower rotating gear 22 to rotate counter-clockwise. As a result, the torsion spring 30 becomes in the state of (d), and the lower rotating gear 22 rotates so as to move the locker 40 to the unlocking position.

If interference occurs in the locker 40, for example, the door is pulled while the door is unlocked, the locker 40 cannot move to the unlocking position even if the driving motor 10 operates. In this case, according to the prior art, the interference of the locker 40 has to be removed, for example, by moving the door to its original position, and then the unlocking operation has to be performed again by a key touch operation or the like. Alternatively, the user has to wait until the interference is removed while the driving motor remains under the load.

In comparison, according to the present invention, the driving motor 10 rotates in a predetermined quantity of rotation regardless of the interference of the locker 40, and the rotation force of the driving motor 10 is converted into the elastic energy of the torsion spring 30 and then is stored. Thereafter, when the interference of the locker 40 is removed, the locker 40 moves to the unlocking position due to a restoring elastic force of the torsion spring 30. As a result, the driving motor 10 can be prevented from damaging while remaining under the load, and the user does not have to perform the unlocking operation again inconveniently.

Likewise, during the locking operation of the door lock system, if interference occurs when the locker 40 rotates, in the same manner described above, the torsion spring 30 stores the rotation force of the driving motor 10 as the elastic force of the spring, so that the locker 40 can automatically operate when the interference is removed.

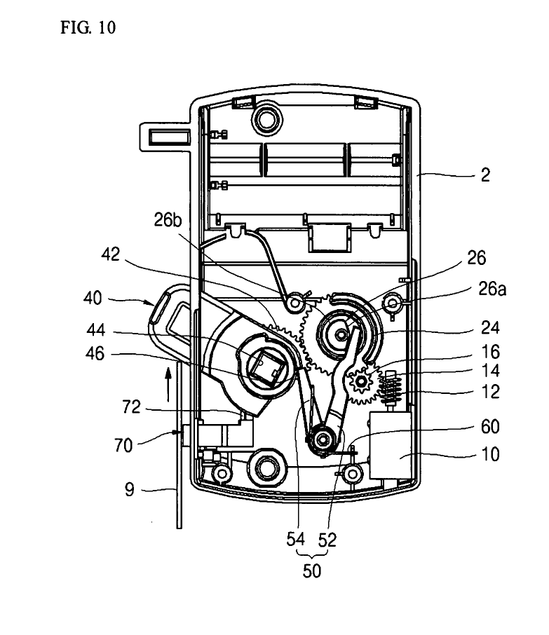

FIG. 10 shows the operation of a safety lever according to an embodiment of the present invention. Here, to open the door, the user rotates the locker 40 from outside by inserting an extra tool such as a card 9 between the door and the door frame after the door lock system is unlocked.

The second lever 52 comes in contact with the lever driving cam 26 at a tilted surface when the door lock system is in the locking state, and the first lever 54 is located at a position where the first lever 54 can come in contact with the stage hook 46 when rotating, that is, the first lever 54 is located at a rotation diameter of the stage hook 46.

Accordingly, if the second lever 52 tries to rotate the locker 40 while not moving the first lever 54 when the lever driving cam 26 rotates, the end of the first lever 54 comes in contact with the stage hook 46 of the locker 40, thereby avoiding the locker 40 from rotating. Therefore, the door can be open only by an appropriate operation such as an electronic key touch operation.

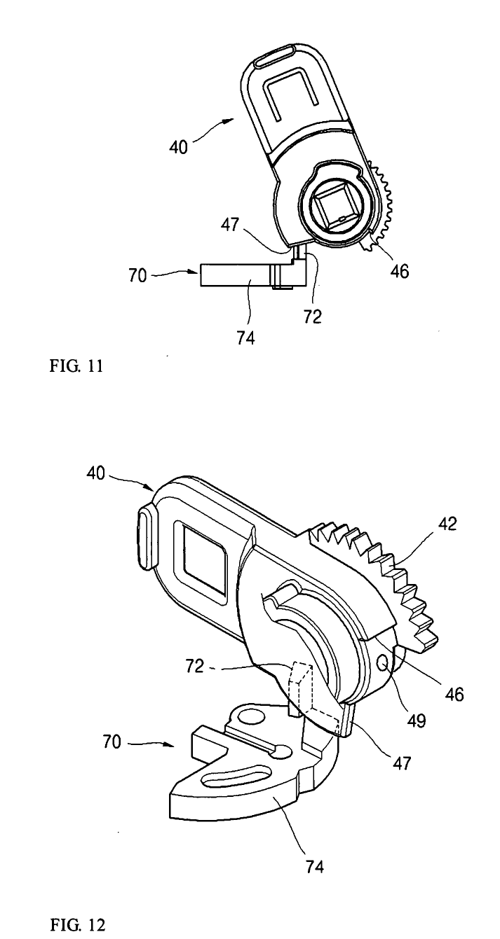

FIGS. 11 and 12 are partial views showing the operation of the supporting portion 70 of the door lock system according to an embodiment of the present invention.

Referring to the drawings, when the locker 40 is in the unlocking position, the supporting lever 72 comes in contact with the tilt portion 47 formed in the rear side of the locker 40, thereby interfering rotation of the locker 40. In this state, if the controller is operated by a key touch operation or a password input operation and rotates the driving motor 40 in the predetermined quantity of rotation, the upper rotating gear 24 rotates, but the lower rotating gear 22 does not rotate in the same manner in which the locker 40 is restricted by interference, and the rotation force is stored as the elastic energy of the torsion spring 30.

If the door is closed in this state, the body 74 of the supporting portion 70 comes in contact with the door frame and thus rotates in a direction perpendicular to the rotation direction of the locker 40, that is, a direction in which the body 74 enters inside the lock case 2. In addition, the supporting lever 72 is separated from the tilt portion 74 and thus moves to a position where the rotation of the locker 40 is not interfered as shown in FIG. 12.

As a result, the locker 40 rotates towards the locking position without interference while the lower rotating gear 22 rotates due to the elastic force of the torsion spring 30.

In this manner, when a door locking signal is provided by the key touch operation or the password input operation in a state that the door is open, even if the driving motor 10 rotates in the predetermined quantity of rotation, the locker 40 can stay in the unlocking position due to the supporting lever 72. When the door is closed, the locker 40 is separated from the supporting lever 72 while the body 74 of the supporting portion 70 rotates, and the locker 40 rotates towards the locking position by the elastic force of the torsion spring 30.

Therefore, even when the door is closed after the door locking signal is provided in a state that the door is open, the present invention can prevent the door being lowered in advance and closed. Thus, the door can be locked without an extra operation even if the user closes the door after providing the door locking signal, thereby improving convenience in use. The supporting portion 70 functions as a safety means which prevents the locker 40 from damaging when the locker 40 is lowered and thus the door is closed in the state that the door is open.

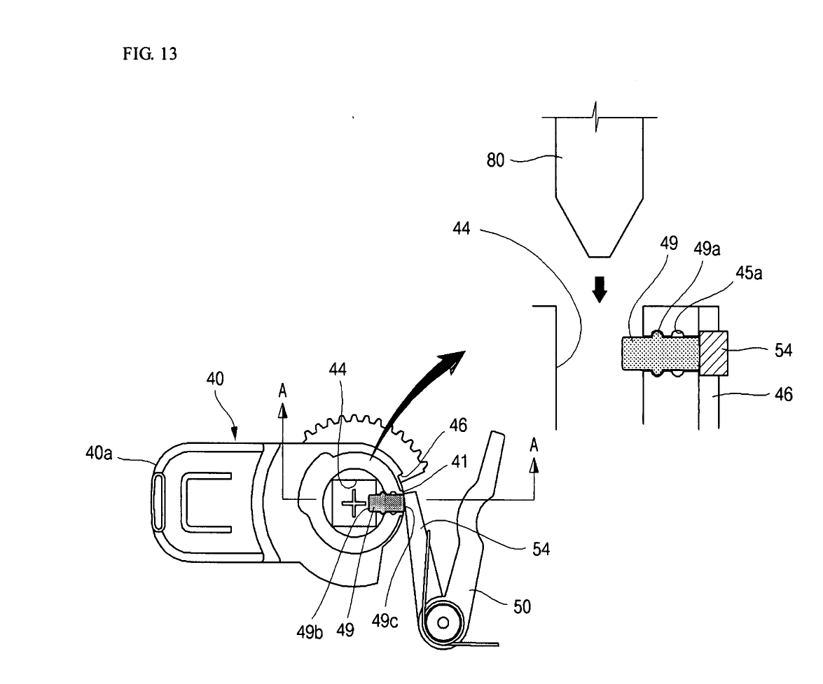

FIGS. 13 to 15 show a compulsive opening structure and the operation of the door lock system according to an embodiment of the present invention.

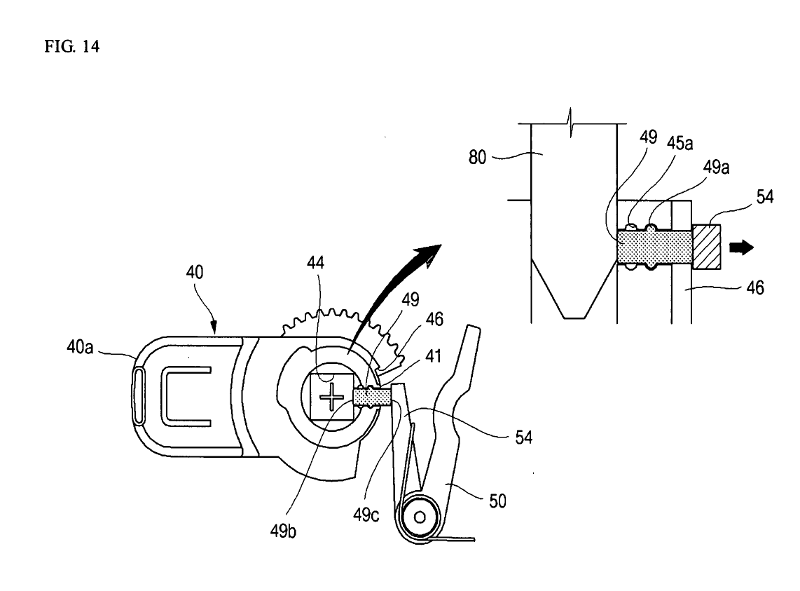

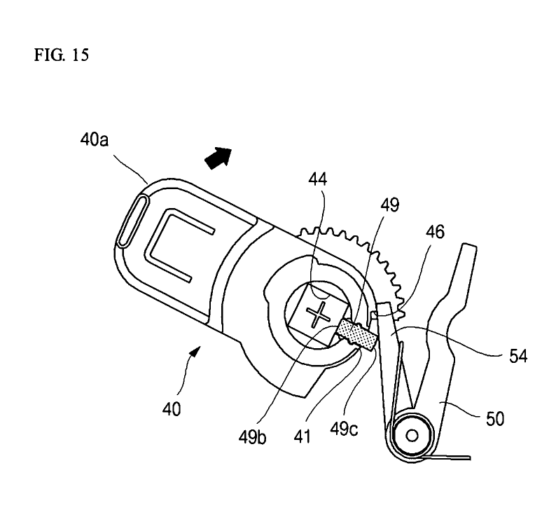

Referring to FIG. 13, a locker hole 44 is formed in the locker 40. A rotation axis 43 is inserted into the locker hole 44, and thus the locker 40 can rotate about the rotation axis 43. According to an embodiment of the present invention, a through-hole 45 is formed in the lateral side of the locker hole 44 of the locker 40, and allows the lower portion of the outer circumferential surface 41 of the stage hook 46, in which the first lever 54 of the antitheft safety lever 50 comes in contact, to be connected with the inside of the locker hole 44. That is, the through-hoe 45 extends in the opposite direction with respect to a hook portion 40a of the locker 40 that is inserted into or separated from the locking notch, and allows the lower outer circumferential surface 41 of the stage hook 46 to be connected with inside the locker hole 44. A compulsive opening pin 49 disposed in the through-hole 45 can compulsively remove interruption of the antitheft safety lever 50. A protrusion 49a is formed on the outer circumferential surface of the compulsive opening pin 49. A plurality of notches 45a to which the protrusion 49a is joined is formed in the through-hole 45. Since the protrusion 49a is joined with the notch 45a, and thus the compulsive opening pin 49 is fastened in a movable manner, the compulsive opening pin 49 can be supported at an original position (see FIG. 10) and a movement position (see FIG. 14).

FIG. 13 shows the compulsive opening pin 49 when the door lock system is in a normal operation state. In the compulsive opening pin 49, a first end 49a disposed inside the locker hole 44 is protruded inwards of the locker hole 44, and a second end 49c is parallel to a rear outer circumferential surface of the locker 40. The compulsive opening pin 49 has a suitable length for the second end 49c to push the first lever 54 of the antitheft safety lever 50 when the first end 49a is pushed in the direction of the outer circumferential surface 41 so as to move out of a rotation path of the stage hook 46.

When the door lock system operates in a normal state, as shown in FIG. 13, the second end 49c of the compulsive opening pin 49 is not protruded from the outer circumferential surface 41, thereby not affecting operations of the locker 40 and the antitheft safety lever 50.

However, when a normal operation becomes impossible by losing the key or the password, or by malfunctioning of an electric circuit while using the door lock system, the door lock system can be open in a compulsive manner by operating the compulsive opening pin 49.

Referring back to FIGS. 1 and 2, in the door lock system, the key contact portion 1a of the front cover 1 lies in the same straight line as the locker hole 44. As a result, the user can find a correct location of the locker hole 44 without having to use an extra indication. If the door lock system needs to be open in a compulsive manner, the user makes a hole in the key contact portion 1a of the front cover 1 by using a drill. Through the hole, the user can insert a driver 80 up to the locker hole 44. Here, the driver 80 can be inserted up to the upper portion of the locker hole 44, that is, a portion which is directed to the front cover 1 and of which a lateral side includes the through-hole 45.

FIG. 14 shows a state in which a hole is formed in the key contact portion 1a and a driver is inserted thereto. When the driver 80 is inserted, the lateral side of the driver 80 comes in contact with the first end 49b of the compulsive opening pin 49, and thus the compulsive opening pin 49 protruded inwards of the locker hole 44 is pushed outside towards the circumferential surface 41. As a result, the second end 49c of the compulsive opening pin 49 pushes the first lever 54 of the antitheft safety lever 50 outside the rotation path of the stage hook 46 of the locker 40. A cross-shaped hole at the center of the locker hole 44 is a driver hole to which the front end of the driver 80 is inserted.

When the user holds and turns the driver 80, the locker 40 rotates as shown in FIG. 15 without being in contact with the antitheft safety lever 50. Accordingly, the user can open the door lock system in a compulsive manner. In the compulsive opening structure of the door lock system, the door can be open at a particular position in a compulsive manner, thereby minimizing damage. Further, since an alarming sound can be generated by sensing a certain impact or operation occurring when the door is compulsively open, it is possible to allow only an owner or an authorized user can open the door in a compulsive manner. Thus, an economic loss or a time loss which are accompanied by the key loss and the password loss can be minimized.

According to the door lock system of the present invention, a driving motor can rotate in a predetermined quantity of rotation even when interference occurs, for example, when a locker is stuck while locking and unlocking operations are performed. Thus, the driving motor can be prevented from overheating, damaging, or malfunctioning. Also, a controller for operating the driving motor can be prevented from damaging. Furthermore, the driving motor does not have to operate twice, and battery exhaustion can be reduced.

In addition, the door lock system of the present invention can have a safe locking function which can prevent the door from opening with a malicious intention by separating a locker from a locking notch without performing a normal unlocking operation, thereby improving a product's reliability.

In addition, a safety means for the door lock system of the present invention can prevent the door lock from damaging when the door is closed by lowering the locker in a state that the door is open.

In addition, in the present invention, the door lock system can be open in a compulsive manner when the door lock system has to be open due to a key loss, a password loss, or malfunctioning, while minimizing damage in the door lock system.

Although the exemplary embodiments of the present invention have been described, the present invention is not limited to the embodiments, but may be modified in various forms without departing from the scope of the appended claims, the detailed description, and the accompanying drawings of the present invention. Therefore, it is natural that such modifications belong to the scope of the present invention.

What is claimed is:

1. A door lock system comprising:
a driving motor which is disposed inside a lock case, has a gear at an end of a motor-axis, and rotates clockwise and counter-clockwise with a predetermined quantity of rotation in response to a door locking signal and a door unlocking signal, respectively;
a locker which has a gear engaged at one side, and moves between the door locking position and the door unlocking position through an aperture formed at one side of the lock case by receiving a driving force of the driving motor; and
a rotating gear group comprising: an upper rotating gear which is disposed between the driving motor and the locker, and rotates along with a motor-axis gear by receiving a rotation force of the motor-axis gear; a lower rotating gear which is disposed at the lower portion of the upper rotating gear, and rotates the gear of the locker while rotating; and a torsion spring which is disposed between the upper rotating gear and the lower rotating gear and converts the rotation force of the upper rotating gear into an elastic force of a spring to be delivered to the lower rotating gear as a rotation force of the lower rotating gear, and thus allows the driving motor to be able to rotate in a predetermined quantity of rotation even when interruption occurs in the locker.

2. The door lock system according to claim 1, wherein the locker is fastened about a rotation axis formed in the lock case in a rotatable manner, the gear has a circular arc shaped engaging surface so that the rotation of the lower rotating gear can be delivered, and the locker rotates between the door locking position and the door unlocking position due to the rotation of the lower rotating gear.

3. The door lock system according to claim 1, wherein a first hook piece and a second hook piece are respectively protruded from the lower surface of the upper rotating gear and the upper surface of the lower rotating gear, the first hook piece and the second hook piece are disposed between both ends of the torsion spring, and the lower rotating gear rotates if one end of the torsion spring presses the second hook piece due to an elastic force produced when a second end of the torsion spring is pressed by the first hook piece while the upper rotating gear rotates.

4. The door lock system according to claim 3, wherein the both ends of the torsion spring extend in a cross manner with each other.

5. The door lock system according to claim 4, wherein the driving motor has quantity of rotation in excess of a suitable rotation range of the lower rotating gear, so that the locker can be prevented from moving due to the elastic force of the torsion spring corresponding to a separation distance between the first hook piece and the second hook piece when the locker is located in the door locking position or the door unlocking position.

6. The door lock system according to claim 2,
wherein a stage hook is formed with one stage in the rear side of the locker, and
wherein the door lock system further comprises:
a lever driving cam which is formed in the upper side of the upper rotating gear in an integrated manner, and includes a first portion having a short rotation diameter and a second portion having a long rotation diameter;
a safety lever comprising: a first lever which is fastened about a rotation axis formed inside the lock case in a rotatable manner, and of which an end can be located on a rotation path of the stage hook; and a second lever which is integrated with the first lever and which extends in contact with the outer circumferential surface of the lever driving cam, so that the first lever does not interfere the rotation of the locker that moves from the door locking position to the door unlocking position when a contact position changes from the first portion to the second portion while the lever driving cam rotates, and thus the first lever moves from the rotation path of the stage hook; and
a spring which provides an elastic force suitable for the second lever to come in contact with the outer circumferential surface of the lever driving cam so that the operation of the safety lever can be related to the rotation of the lever driving cam.

7. The door lock system according to claim 6, wherein the first portion of the lever driving cam has two tilted surfaces in the form of a triangle, and the second portion has a circular arc shaped surface, so that the inner surface of the second lever comes in contact with the tilt portion of the lever driving cam when the locker is in a locking state, and the inner surface of the second lever comes in contact with the circular arc position of the lever driving cam while the lever driving cam rotates along with the upper rotating gear.

8. The door lock system according to claim 6,
wherein a locker hole is formed in a rotation center where the rotation axis is joined,
wherein a through-hole is formed in the lateral side of the locker hole and allows the outer circumferential surface at the lower portion of the stage hook, in which the first lever of the safety lever is adjacent when the locker is in the locking position, to be connected with the inside of the locker hole, and
wherein the through-hole has a compulsive opening pin of which a first end is protruded inwards of the locker hole and which has a suitable length for the second end to push the first lever of the safety lever when the first end is pushed in the direction of the outer circumferential surface so as to move out of a rotation path of the stage hook.

9. The door lock system according to claim 8, wherein the locker hole lies in the same straight line as a key contact portion included in a front cover.

10. The door lock system according to claim 9, wherein a driver can be inserted up to the locker hole through a hole formed by drilling the key contact portion, the compulsive opening pin moves in the direction of the outer circumferential surface when the driver is inserted into the locker hole, and the locker can rotate along with the rotation of the driver.

11. The door lock system according to claim 8, wherein a protrusion is formed on the outer circumferential surface of the compulsive opening pin, and a plurality of notches is formed in the through-hole along an extension direction so that the compulsive opening pin can be supported at an original position and a movement position due to bonding with the protrusion.

12. The door lock system according to claim 2,
wherein a tilt portion is formed in the rear side of the locker, and
wherein the door lock system further comprises:
a supporting lever which extends upwards from the body, and comes in contact with the tilt portion of the locker in the unlocking position when the body is protruded; and
a supporting portion which has an operating spring for providing an elastic force so that the body is protruded through the through-hole when the locker is in the unlocking position.

13. The door lock system according to claim 1, further comprising:
a driving gear which is engaged with the motor-axis gear; and
a operation gear which is coaxially connected to the driving gear, rotates along with the driving gear, and is engaged with the motor-axis gear, wherein
the upper rotating gear can rotate along with the rotation of the motor-axis gear.
